(19) United States
(12) Patent Application Publication
(10) Pub. No.: US 2024/0211175 A1
(43) Pub. Date: Jun. 27, 2024

(54) DATA WRITING AND RECOVERY METHOD FOR USE IN QUADRUPLE-LEVEL CELL FLASH MEMORY AND RELATED AND MEMORY CONTROLLER AND STORAGE DEVICE

(71) Applicant: Silicon Motion, Inc., Hsinchu County (TW)

(72) Inventor: Tsung-Chieh Yang, Hsinchu City (TW)

(73) Assignee: Silicon Motion, Inc., Hsinchu County (TW)

(21) Appl. No.: 18/391,703

(22) Filed: Dec. 21, 2023

Related U.S. Application Data
(60) Provisional application No. 63/434,900, filed on Dec. 22, 2022.

(30) Foreign Application Priority Data
Nov. 2, 2023 (TW) 112142196

(51) Int. Cl. G06F 3/06

(52) U.S. Cl. CPC G06F 3/0659; G06F 3/0619; G06F 3/064; G06F 3/0679

(57) ABSTRACT

A data recovery method for a flash memory includes: during a first programming pass, programming a memory cell of the flash memory to a specific charge state, thereby to store middle page data and lower page data into the memory cell; reading the memory cell to back up one of the middle page data and the lower page data stored in the memory cell to another memory cell in the flash memory; upon detecting an error during or after a second programming pass, based on a current voltage of the memory cell and the backed-up one of the middle page data and the lower page data from the another memory cell of the flash memory, recovering the middle page data and the lower page data of the memory cell; and writing back the recovered middle page data and the recovered lower page data to the flash memory.

### CROSS REFERENCE TO RELATED APPLICATIONS

This application claims the benefit of U.S. Provisional Application No. 63/434,900, filed on Dec. 22, 2022. The content of the application is incorporated herein by reference.

### BACKGROUND OF THE INVENTION

### 1. Field of the Invention

The present invention relates to flash memory, and more particularly to methods of data writing and recovery, corresponding memory controllers and data storage devices that enhances the data integrity, storage reliability, and read/write efficiency of quadruple-level cell (QLC) flash memory.

### 2. Description of the Prior Art

Quadruple-level cell (QLC) flash memory is an advanced storage technology, whose primary advantage lies in significantly increasing storage density. Each QLC memory cell can store information of 4 bits, meaning that QLC technology can store more information in the same physical space compared to single-level cell (SLC), multi-level cell (MLC), and triple-level cell (TLC) technologies. This higher storage density makes QLC flash memory a highly cost-effective storage solution, particularly suitable for large data storage and enterprise applications. However, as each QLC memory cell may have 16 possible charge states (corresponding to 4 bits), this leads to higher difficulty in discerning charge states and a greater likelihood of errors during writing and reading. Consequently, QLC flash memory has slower read and write speeds and a relatively higher rate of read and write errors compared to other technologies. It is evident that QLC flash memory requires more advanced write management mechanisms to overcome its inherent shortcomings.

### SUMMARY OF THE INVENTION

To enhance data integrity, storage reliability, and read/write efficiency of quadruple-level cell (QLC) flash memory, the present invention provides methods for data writing and recovery, as well as related memory controllers and data storage devices. The data writing method of the present invention allows for conversion of lower-level memory cell blocks to higher-level memory cell blocks through multiple programming operations, without performing garbage collection. This approach not only maintains the integrity of original data but also improves writing efficiency. Furthermore, the data recovery method of the present invention employs specific programming schemes, using minimal data backup between multiple programming operations to ensure the protection of data integrity.

According to one embodiment, a data writing method for use in a flash memory is provided. The data writing method comprises: configuring one or more blocks of a plurality of blocks of the flash memory as one or more single-level cell (SLC) blocks; based on one or more first host write commands, writing one or more first user data, as requested by the one or more first host write commands, to lower pages of the one or more SLC blocks; in response to determining that a writable space in the flash memory is below a first predetermined value, configuring the one or more SLC blocks as one or more multi-level cell (MLC) blocks; and based on one or more second host write commands, writing one or more second user data, as requested by the one or more second host write commands, to middle pages of the one or more MLC blocks without performing a garbage collection operation. Specifically, the one or more first user data are retained in lower pages of the one or more MLC blocks.

According to one embodiment, a data recovery method for data recovery in a flash memory is provided. The data recovery comprises: during a first programming pass, programming a memory cell of the flash memory to a specific charge state, thereby to store middle page data and lower page data into the memory cell; reading the memory cell to back up one of the middle page data and the lower page data stored in the memory cell to another memory cell in the flash memory; upon detecting an error during or after a second programming pass, based on a current voltage of the memory cell and the backed-up one of the middle page data and the lower page data from the another memory cell of the flash memory, recovering the middle page data and the lower page data of the memory cell; and writing back the recovered middle page data and the recovered lower page data to the flash memory.

According to one embodiment, a memory controller for use in a flash memory is provided. The memory controller comprises: a storage unit and a processing unit. The storage unit is configured to store program codes. The processing unit is configured to execute the program code to perform write operations on the flash memory, comprising: configuring one or more blocks of a plurality of blocks of the flash memory as one or more single-level cell (SLC) blocks; based on one or more first host write commands, writing one or more first user data, as requested by the one or more first host write commands, to lower pages of the one or more SLC blocks; in response to determining that a writable space in the flash memory is below a first predetermined value, configuring the one or more SLC blocks as one or more multi-level cell (MLC) blocks; and based on one or more second host write commands, writing one or more second user data, as requested by the one or more second host write commands, to middle pages of the one or more MLC blocks without performing a garbage collection operation. Specifically, the one or more first user data are retained in lower pages of the one or more MLC blocks.

According to one embodiment, a memory controller for use in a flash memory is provided. The memory controller comprises: a storage unit and a processing unit. The storage unit is configured to store program codes. The processing unit is configured to execute the program code to perform write operations on the flash memory, comprising: during a first programming pass, programming a memory cell of the flash memory to a specific charge state, thereby to store middle page data and lower page data into the memory cell; reading the memory cell to back up one of the middle page data and the lower page data stored in the memory cell to another memory cell in the flash memory; upon detecting an error during or after a second programming pass, based on a current voltage of the memory cell and the backed-up one of the middle page data and the lower page data from the another memory cell of the flash memory, recovering the middle page data and the lower page data of the memory cell; and writing back the recovered middle page data and the recovered lower page data to the flash memory.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a storage device according to one embodiment of the present invention.

FIG. 2 illustrates a programming scheme and process corresponding to an inventive data writing method according to one embodiment of the present invention.

FIG. 3A illustrates a QLC memory cell programming scheme according to one embodiment of the present invention.

FIG. 3B illustrates a QLC memory cell programming scheme according to another embodiment of the present invention.

FIG. 3C illustrates a QLC memory cell programming scheme according to yet another embodiment of the present invention.

FIG. 4A illustrates a programming process of QLC memory cell programming scheme of FIG. 3A.

FIG. 4B illustrates a programming process of QLC memory cell programming scheme of FIG. 3B.

FIG. 4C illustrates a programming process of QLC memory cell programming scheme of FIG. 3C.

FIG. 5 illustrates a flow chart of a data recovery method according to one embodiment of the present invention.

### DETAILED DESCRIPTION

In the following description, numerous specific details are set forth in order to provide a thorough understanding of the present embodiments. It will be apparent, however, to one having ordinary skill in the art that the specific detail need not be employed to practice the present embodiments. In other instances, well-known materials or methods have not been described in detail in order to avoid obscuring the present embodiments.

Reference throughout this specification to “one embodiment” or “an embodiment” means that a particular feature, structure or characteristic described in connection with the embodiment or example is included in at least one embodiment of the present embodiments. Thus, appearances of the phrases “in one embodiment” or “in an embodiment” in various places throughout this specification are not necessarily all referring to the same embodiment. Furthermore, the particular features, structures or characteristics may be combined in any suitable combinations and/or sub-combinations in one or more embodiments.

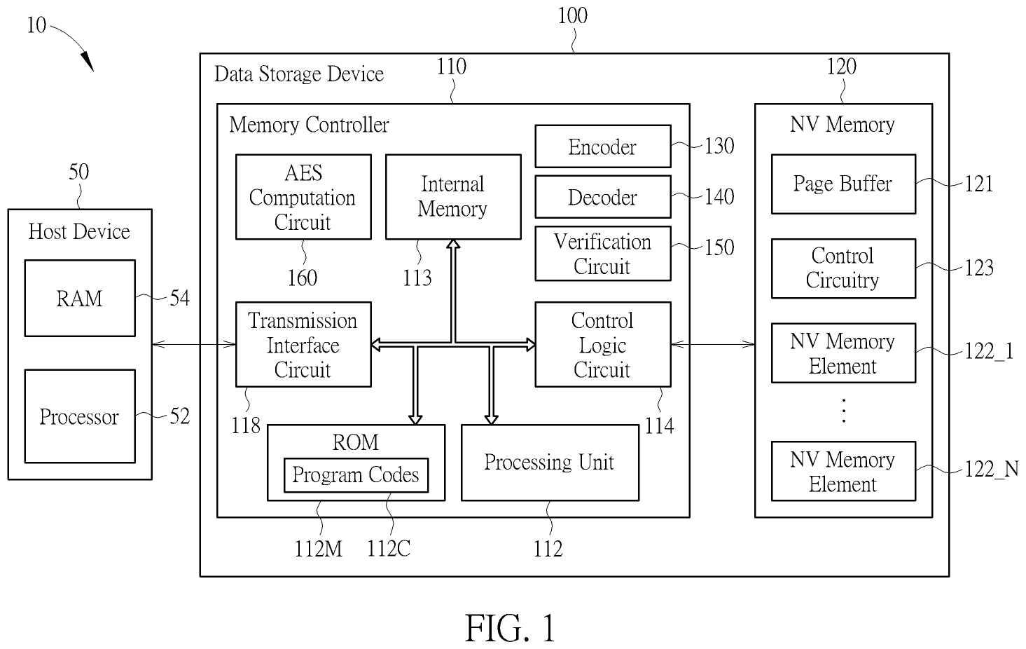

FIG. 1 is a schematic diagram illustrating an electronic device 10 according to one embodiment of the present invention, where the electronic device 10 comprises a host device 50 and a data storage device 100. The host device 50 May comprise: at least one processor 52 configured to control operations of the host device 50, and a random access memory 54 configured to store data and information required by the processor 52. Examples of the host device 50 May include, but are not limited to: a smartphone, a tablet computer, a wearable device, a personal computer such as a desktop computer or a laptop computer, an imaging device such as a digital still camera or a video camera, a game console, a car navigation system, a printer, a scanner, or a server system. Examples of the data storage device 100 may include, but are not limited to: a portable memory device (such as a memory card conforming to SD/MMC, CF, MS, XD, or UFS specifications), a solid-state drive (SSD), and various embedded storage devices (such as an embedded storage device conforming to UFS or EMMC specifications).

According to various embodiments, the data storage device 100 may comprise a controller such as a memory controller 110 and may further comprise a non-volatile (NV) memory 120. The NV memory 120 is configured to store data and information. The NV memory 120 may comprise one or more NV memory elements, such as a plurality of NV memory elements 122_1-122_N. For example, the NV memory 120 may be a flash memory, and the NV memory elements 122_1-122_N may be a plurality of flash memory chips or a plurality of flash memory dies, respectively, but the present invention is not limited thereto. In addition, the NV memory 120 may comprise memory cells having a two-dimensional structure or memory cells having a three-dimensional structure.

As shown in FIG. 1, the memory controller 110 may comprise a processing unit 112, a read-only memory (ROM) 112M, an internal memory 113, a control logic circuit 114, and a transmission interface circuit 118, a buffer 125, an encoder 130, a decoder 140 and a verification circuit 150, an advanced encryption standard (AES) computation circuit 160. At least one portion (e.g. a portion or all) of these circuits and components may be coupled to one another through a bus. The internal memory 113 can be implemented by one or more RAM devices. For example, the internal memory 113 may be a static RAM (SRAM) and/or a dynamic RAM (DRAM). The internal memory 113 may be configured to provide internal storage space for the memory controller 110, for example, temporarily storing information, such as data, addresses, commands, mapping information, and/or variable/parameters. In some embodiments, the memory controller 110 may not include the internal memory 113. Instead, the memory controller 110 may rely on host memory buffer (HMB) technology. With the HMB technology, the memory controller 110 could utilize the RAM 54 (such as DRAM) of the host device 50, as a whole, a part or an extension of the internal memory 113, thereby improving read and write performance of the data storage device 100. Moreover, the buffer 125 could be a part of the internal memory 113. The ROM 112M in this embodiment is configured to store a program code 112C, and the processing unit 112 is configured to execute the program code 112C to control access of the NV memory 120. Alternatively, the program code 112C may be stored in the NV memory 120.

The memory controller 110 controls reading, writing, and erasing of the NV memory 120 through a control logic circuit 114. In addition, the memory controller 110 could perform writing of data based on host commands from the host device 50 and writing of valid data which is read from the NV memory 120 by a garbage collection and/or wear-leveling operations concurrently. The control logic circuit 114 may be further configured to control the NV memory 120 and comprise an Error Correction Code (ECC) circuit (not shown), to perform data protection and/or error correction, but the present invention is not limited thereto. The transmission interface circuit 118 may conform to a specific communications specification (such as Serial Advanced Technology Attachment (SATA) specification, Universal Serial Bus (USB) specification, Peripheral Component Interconnect Express (PCI-E) specification, embedded Multimedia Card (eMMC) specification, or Universal Flash Storage (UFS) specification) and may perform communications with the host device 50 according to the specific communications specification.

Typically, the host device 50 May indirectly access the memory device 100, through transmitting host commands and corresponding logic addresses to the memory controller 110. The memory controller 110 receives the host commands and the logic addresses, and translates the host commands to memory operation commands, and further controls the NV memory 120 with the memory operation commands to perform read, program or erase operations upon memory cells or data pages having physical addresses within the NV memory 120. The NV memory 120 includes one or more page buffers 121 (which may be implemented by SRAM), and one or more control circuits 123. Data that the memory controller 110 intends to program to the NV memory 120 will be written into the page buffer 121. The one or more control circuits 123 will read, program, or erase data based on the memory operation commands sent by the memory controller 110. When the memory controller 110 performs an erase operation on any one of the multiple NV memory elements 122_1-122_N, at least one block in the NV memory element 122_k may be erased. In addition, each block of the NV memory element 122_k can include multiple pages, and access operations (for example, read or write) are performed on one or more pages.

In one embodiment, each of the NV memory elements 122_1-122_N may be a NV memory die or chip. Each of NV memory dies 122_1-122_N is equipped with control circuitry for executing memory operation commands issued by the memory controller 110. Additionally, each of NV memory dies 122_1-122_N may include multiple planes. Each plane might have multiple blocks composed of memory cells, along with associated row and column control circuitry. Memory cells in each plane can be arranged in either a 2D or 3D memory structure. Moreover, through multi-plane operation commands, various memory operations can be parallel or simultaneously performed on different planes. That is, memory operations can be applied parallel or simultaneously on memory blocks of different planes to perform multi-plane reading, writing or erasing operations.

In one embodiment, the memory controller 110 can be utilized to combine memory blocks of the NV memory 120 into multiple super blocks. In one embodiment, a composition of a super block can span across NV memory chips 122_1-122_N. Additionally, the super block can be utilized as one or more storage blocks in each of NV memory chips 122_1-122_N.

In one embodiment, a logical-to-physical (L2P) address mapping table having multiple L2P address mapping entries, can be divided into multiple mapping groups. Each mapping group includes a part of entries of the L2P address mapping table and is utilized for performing logical-to-physical address translation. These L2P mapping groups are permanently stored in blocks of NV memory 120 and are loaded into the internal memory 113 when needed. Similarly, a physical-to-logical (P2L) address mapping table having multiple P2L address mapping entries, can be divided into multiple mapping groups. Each mapping group includes a part of entries of the P2L address mapping table and is utilized for performing physical to logical address translation. These P2L mapping groups are permanently stored in blocks of NV memory 120 and are loaded into the internal memory 113 when needed.

In one embodiment, a data writing method is provided. The data writing method allows for reprogramming of memory cells that have already been written to when a writable space of the NV memory 120 (such as a total space of writable blocks or pages) falls below a predetermined value. Specifically, blocks initially configured as SLC blocks are directly converted into MLC, TLC, and QLC blocks in various embodiments of the present invention. In contrast, in the conventional art, when facing insufficient writable space in flash memory, written data will be typically moved from multiple SLC blocks to a blank (erased) MLC, TLC, or QLC block through garbage collection, or moved from multiple MLC blocks to a blank TLC or QLC block, before converting lower-level blocks to higher-level blocks. In the embodiments of the present invention, the data writing method can be achieved solely through internal reading of the NV memory 120, where original stored data is read from the memory cells and then written back (optionally through the page buffer 121 and control circuit 123), without the need for garbage collection operations, thus offering improved writing efficiency.

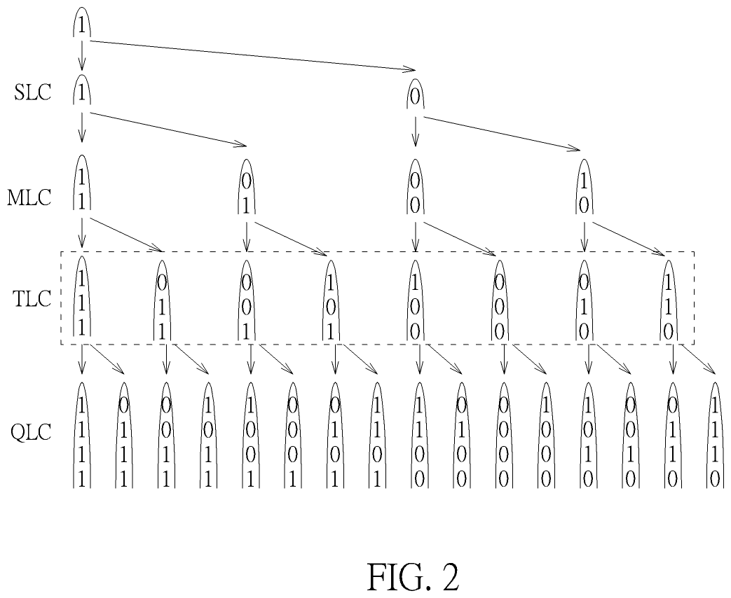

Please refer to a programming scheme and process as illustrated in FIG. 2. As illustrated, when a writable space (or space already written to) in the NV memory 120 is above (or the space already written to below) a first predetermined value (e.g., the number of written blocks or pages is below 25% of the total number of blocks or pages), one or more blocks in the NV memory 120 are configured as SLC blocks. That is, the memory controller 110, based on host write commands for requesting writing one or more (first) user data, would perform first writing to blank memory cells in these blocks, converting the blank memory cells into SLC memory cells with only lower page data. When the writable space (or space already written to) in the NV memory 120 falls between the first predetermined value and a second predetermined value (e.g., the number of written blocks or pages is 25%-50% of the total number of blocks or pages), the one or more SLC blocks are reconfigured as MLC blocks. In other words, the memory controller 110, based on host write commands for requesting writing one or more (second) user data, would perform the first overwriting on these SLC blocks. That is, the memory controller 110 would reprogram the SLC memory cells in the SLC blocks that have already been written to, converting the SLC memory cells into MLC memory cells with both middle page data and lower page data.

In one embodiment, when the writable space (or space already written to) in NV memory 120 falls between the second predetermined value and a third predetermined value (e.g., the number of written blocks or pages is 50% to 75% of the total number of blocks or pages), the one or more MLC blocks are reconfigured as TLC blocks. That is, the memory controller 110, based on host write commands for requesting writing one or more (third) user data, would perform second overwriting on the MLC blocks, reprogramming the MLC memory cells in the MLC blocks that have already been written to, converting the MLC memory cells into TLC memory cells with upper page, middle page, and lower page data. When the writable space (or space already written to) in NV memory 120 falls between the third predetermined value and a fourth predetermined value (e.g., the number of written blocks or pages is 75% to 100% of the total number of blocks or pages), the one or more TLC blocks are reconfigured as QLC blocks. That is, the memory controller 110, based on host write commands for requesting writing one or more (fourth) user data, would perform third overwriting on the TLC blocks, reprogramming the TLC memory cells in the TLC blocks that have already been written to, converting the TLC memory cells into QLC memory cells with top page, upper page, middle page, and lower page data.

In one embodiment, when the writable space (or space already written to) in NV memory 120 falls between the second and third predetermined values (e.g., the number of written blocks or pages is 50% to 75% of the total number of blocks or pages), the memory controller 110 may directly reconfigure the one or more MLC blocks as QLC blocks during the second overwriting based on the host write commands for requesting writing one or more (third) user data. That is, the memory controller 110 would perform a programming operation on the MLC memory cells in the MLC blocks that have already been written to, converting the MLC memory cells into QLC memory cells with top page, upper page, middle page, and lower page data.

As can be seen from FIG. 2, overwriting operations of the present invention do not result in the loss of original stored data. Instead, by reprogramming operations, the data storage density of the memory cells is increased. For example, in FIG. 2, if a memory cell is previously configured as a TLC memory cell and its original stored data is “001”, it can be then reprogrammed as a QLC memory cell to further store “1001” or “0001”. In this way, the original upper page, middle page, and lower page data (“001”) are retained, and top page data of 0 or 1 can be further stored into. Alternatively, if a memory cell is previously configured as an MLC memory cell and its original stored data is “11”, it can be then reprogrammed as a QLC memory cell to further store “1111”, “0111”, “0011”, or “1011”. In this way, the original middle page data and lower page data are still retained, and top page data and upper page data “11”, “01”, “00”, or “10” can be further stored into. Additionally, in this embodiment, the programming scheme for blocks of each level is based on gray-code mapping principle, where there is only a single bit change between storage information that adjacent charge states correspond to.

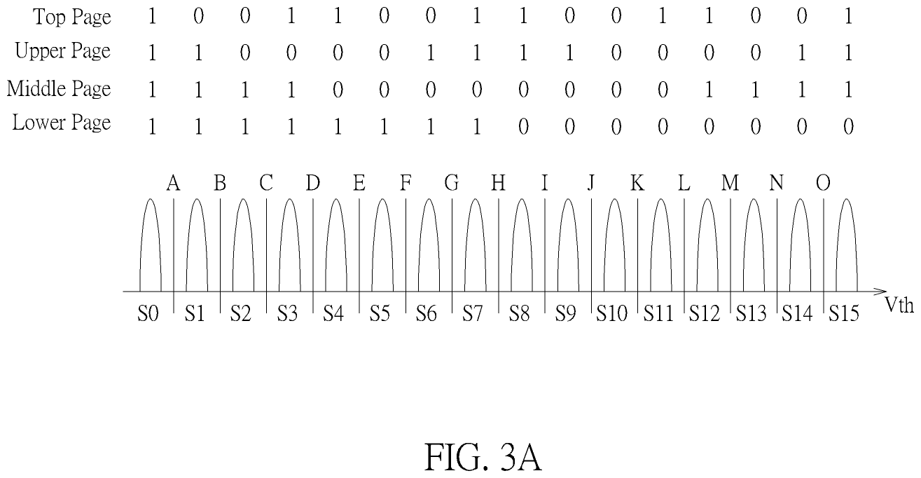

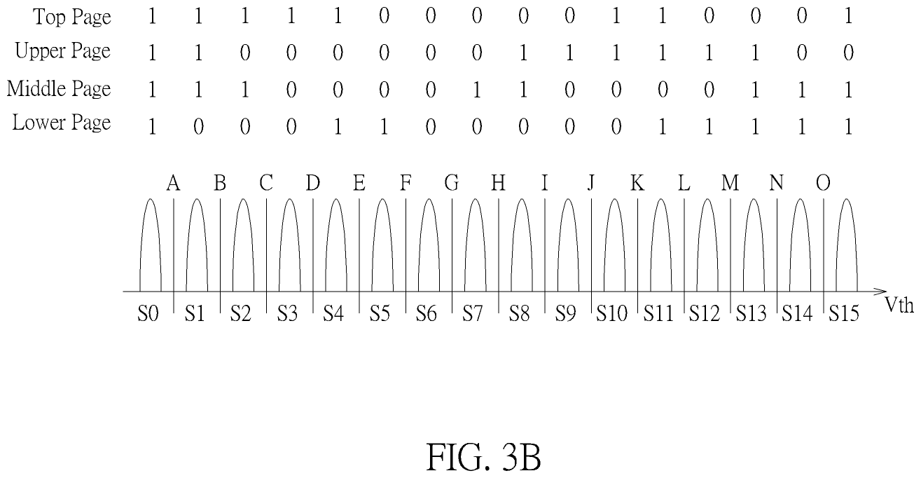

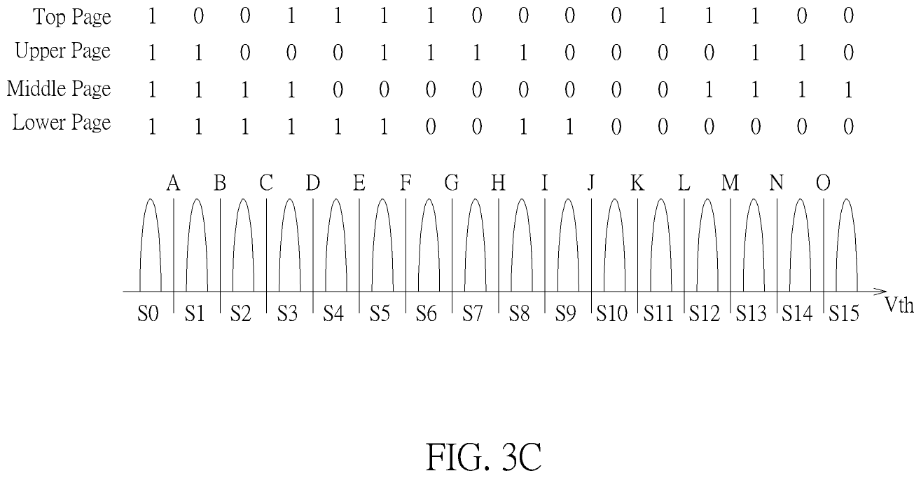

Additionally, the present invention further proposes a data recovery method that ensures the integrity of a large amount of data with minimal data backup. For further details, please refer to FIGS. 3A, 3B, and 3C, which illustrate programming scheme for QLC blocks according to one embodiment of the present invention. In these embodiments, the programming scheme for QLC blocks is based on gray-code mapping principle. To store 16 types of storage information of QLC architecture, QLC memory cells can be programmed into 16 different charge states (S0-S15), defining 15 threshold voltages Vth(A-O). Each charge state is mapped to specific storage information. In the programming scheme adopted in this embodiment, there is only a one-bit change between storage information that adjacent charge states correspond to. For example, in FIG. 3A, charge state S1 corresponds to storage information 0111, with its adjacent charge state S0 corresponding to storage information 1111, and its adjacent charge state S2 corresponding to storage information 0011. Between storage information 0111 and 1111, as well as between storage information 0111 and 0011, there is only a one-bit change. Furthermore, in FIG. 3B, charge state S14 corresponds to storage information 0011, with its adjacent charge state S13 corresponding to storage information 0111, and its adjacent charge state S15 corresponding to storage information 1011. Between storage information 0011 and 0111, as well as between storage information 0011 and 1011, there is also only a one-bit change. Moreover, in FIG. 3C, charge state S7 corresponds to storage information 0100, with its adjacent charge state S6 corresponding to storage information 1100, and its adjacent charge state S8 corresponding to storage information 0101. Between storage information 0100 and 1100, as well as between storage information 0010 and 0101, there is also only a one-bit change.

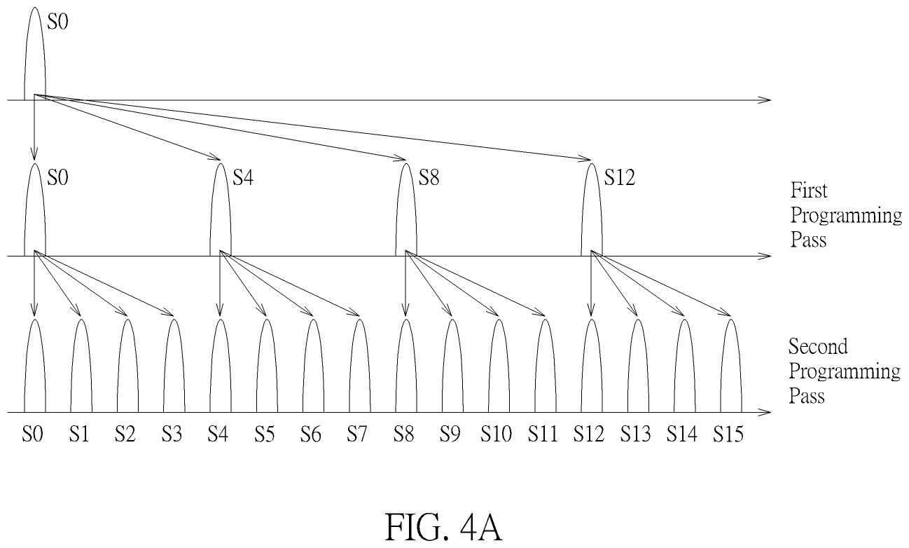

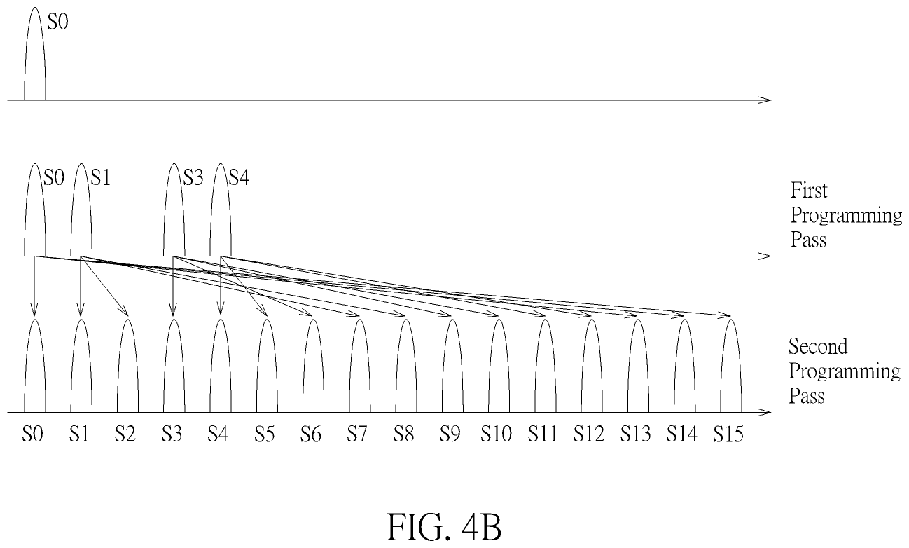

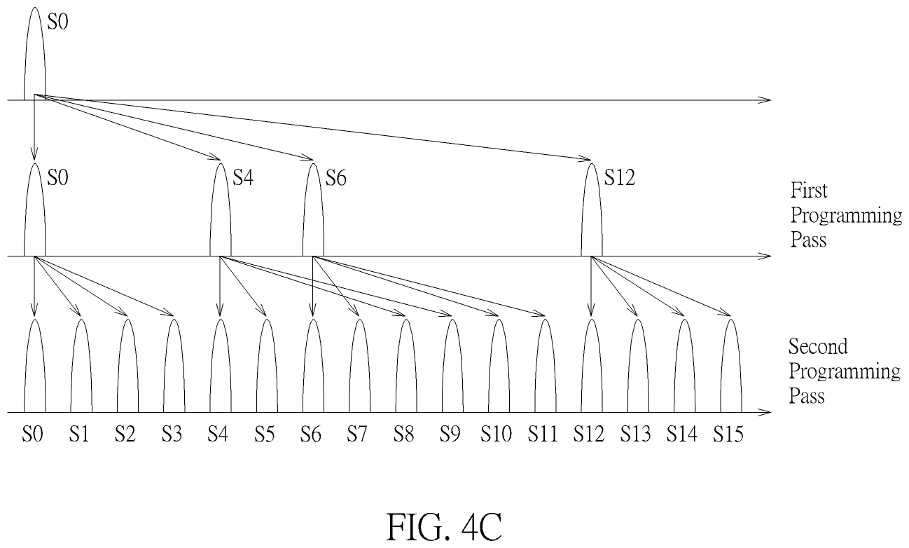

The programming scheme adopted in embodiments of the present invention can be combined with the following programming process to enhance the efficiency of data recovery. For further explanation, please refer to FIGS. 4A, 4B and 4C. FIG. 4A illustrates a programming process corresponding to the programming scheme shown in FIG. 3A. As shown, during a first programming pass, middle page data and lower page data are written, and memory cells can be programmed from charge state S0 (i.e., the erased state) (corresponding to “1”) to charge state S0 (corresponding to “11”), charge state S4 (corresponding to “01”), charge state S8 (corresponding to “00”), or charge state S12 (corresponding to “10”) (as MLC memory cells). In a second programming pass, while maintaining the middle page data and lower page data unchanged, top page data and upper page data are then written, and the (MLC) memory cells can be converted as QLC memory cells by being programmed:
from charge state S0 (corresponding to “11”) to charge state S0 (corresponding to “1111”), charge state S1 (corresponding to “0111”), charge state S2 (corresponding to “0011”), or charge state S3 (corresponding to “1011”);
from charge state S4 (corresponding to 01) to charge state S4 (corresponding to “1001”), charge state S5 (corresponding to “0001”), charge state S6 (corresponding to “0101”), or charge state S7 (corresponding to “1101”);
from charge state S8 (corresponding to 00) to charge state S8 (corresponding to “1100”), charge state S9 (corresponding to “0100”), charge state S10 (corresponding to “0000”), or charge state S11 (corresponding to “1000”); and
from charge state S12 (corresponding to 10) to charge state S12 (corresponding to “1010”), charge state S13 (corresponding to “0010”), charge state S14 (corresponding to “0110”), or charge state S15 (corresponding to “1110”).

Please refer to FIG. 4B, which illustrates a programming process corresponding to the programming scheme shown in FIG. 3B. As illustrated, during a first programming pass, middle page data and lower page data are written, and memory cells can be programmed from charge state S0 (corresponding to 1) to charge state S0 (corresponding to “11”), charge state S1 (corresponding to “10”), charge state S3 (corresponding to “00”), or charge state S4 (corresponding to “01”) (as MLC memory cells). In a second programming pass, while maintaining the middle page data and lower page data unchanged, top page data and upper page data are then written, and the (MLC) memory cells can be converted as QLC memory cells by being programmed:
from charge state S0 (corresponding to “11”) to charge state S0 (corresponding to “1111”), charge state S13 (corresponding to “0111”), charge state S14 (corresponding to “0011”), or charge state S15 (corresponding to “1011”);
from charge state S1 (corresponding to “10”) to charge state S1 (corresponding to “1110”), charge state S2 (corresponding to “1010”), charge state S7 (corresponding to “0010”), or charge state S8 (corresponding to “0110”);
from charge state S3 (corresponding to “00”) to charge state S3 (corresponding to “1000”), charge state S6 (corresponding to “0000”), charge state S9 (corresponding to “0100”), or charge state S10 (corresponding to “1100”); and
from charge state S4 (corresponding to “01”) to charge state S4 (corresponding to “1001”), charge state S5 (corresponding to “0001”), charge state S11 (corresponding to “1101”), or charge state S12 (corresponding to “0101”).

Please refer to FIG. 4C, which illustrates a programming process corresponding to the programming scheme shown in FIG. 3C. As illustrated, during a first programming pass, middle page data and lower page data are written, and memory cells can be programmed from charge state S0 (corresponding to 1) to charge state S0 (corresponding to “11”), charge state S4 (corresponding to “01”), charge state S6 (corresponding to “00”), or charge state S12 (corresponding to “10”) (as MLC memory cells). In a second programming pass, while maintaining the middle page data and lower page data unchanged, top page data and upper page data are then written, and the (MLC) memory cells can be converted as QLC memory cells by being programmed:
from charge state charge state S0 (corresponding to “11”) to charge state S0 (corresponding to “1111”), charge state S1 (corresponding to “0111”), charge state S2 (corresponding to “0011”), or charge state S3 (corresponding to “1011”); from charge state S4 (corresponding to “01”) to charge state S4 (corresponding to “1001”), charge state S5 (corresponding to “1101”), charge state S8 (corresponding to “0101”), or charge state S9 (corresponding to “0001”);
from charge state S6 (corresponding to “00”) to charge state S6 (corresponding to “1100”), charge state S7 (corresponding to “0100”), charge state S10 (corresponding to “0000”), or charge state S11 (corresponding to “1000”); and
from charge state S12 (corresponding to “10”) to charge state S12 (corresponding to “1010”), charge state S13 (corresponding to “1110”), charge state S14 (corresponding to “0110”), or charge state S15 (corresponding to “0010”).

In the aforementioned programming processes, the memory controller 110 might not continuously perform the first and second programming passes on memory cells of a same wordline. In the meantime, if a sudden power-off event occurs, the voltages of the memory cells that have undergone the first programming pass would be in an inaccurate state. This means that data (i.e., the written middle page data and the written lower page data) on these memory cells might be erroneous. To address such issue, the memory controller 110 will execute a sudden power-off recovery (SPOR) process, attempting to recover the middle page data and lower page data of the memory cells that have undergone the first programming pass.

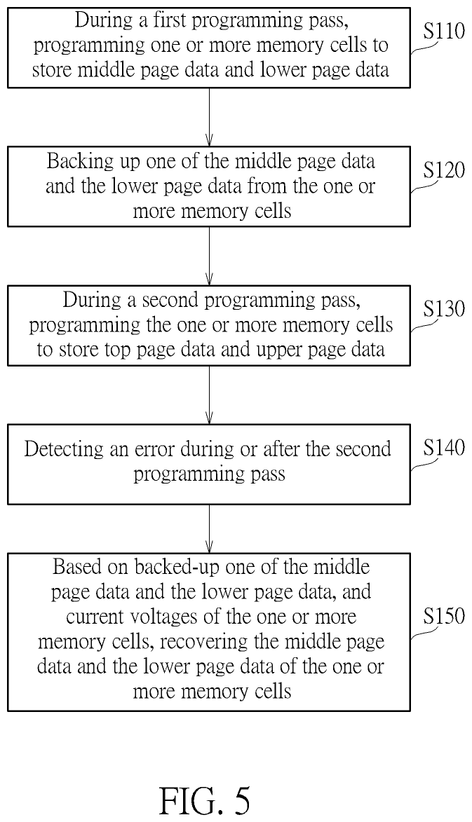

Please refer to FIG. 5, which illustrates a flow chart of a data recovery method according to one embodiment of the present invention. As shown, at step S110, during a first programming pass, one or more memory cells are programmed to a specific charge state to store middle page data and lower page data (converted as MLC memory cells). Then, at step S120, one of the written middle page data and the written lower page data is read from the memory cells and backed up by storing the one of the written middle page data and the written lower page data into other memory cells of NV memory 120. Specifically, the abovementioned other memory cells can (but are not limited to) belong to an SLC block. At step S130, during a second programming pass, the one or more memory cells are programmed to store top page data and upper page data, converting the one or more memory cells into QLC memory cells. At step S140, a sudden power-off event is detected during the second programming pass, or a programming error is detected after the second programming pass (through a read-back check). The flow then proceeds to step S150, where one of backed-up middle page data or backed-up lower page data is read out from the aforementioned SLC block. Based on current voltages of the one or more memory cells, the middle page data and the lower page data of the one or more memory cells are recovered and written back into the NV memory 120.

Regarding the data recovery method, please refer to the programming scheme and process illustrated in FIG. 3C and FIG. 4C. As shown, based on the programming scheme of FIG. 3C, during a second programming pass, if a memory cell is programmed from charge state S4 to charge state S8 or charge state S9, or from charge state S6 to charge state S6 or charge state S7, there could be a situation of ambiguous voltage. This is because charge states S8 and S9 corresponding to higher voltages are transitions from charge states S4 corresponding to a lower voltage, while the charge states S6 and S7 corresponding to lower voltages (relative to charge states S8 or S9) are transitions from the charge state S6 corresponding to higher voltage (relative to the charge state S4). If a sudden power-off event or a programming error occurs during the second programming pass, this could lead to aliasing, making it difficult to distinguish an exact charge state of the memory cell. In such cases, the memory controller 110 will read a voltage of the memory cell and lower page data backed up in step S120 to recover the lower page data and the middle page data of the memory cell.

Due to aliasing phenomenon, when a voltage of a memory cell falls within a voltage range corresponding to charge states S6, S7, S8, and S9, the memory controller 110 cannot determine which of these charge states the memory cell is intended to be programmed to during the second programming pass. However, since the middle page data and the lower page data corresponding to charge states S6, S7, S8, and S9 differ only in the lower page data, the memory controller 110 can recover the lower page data of the memory cell by using the backed-up lower page data. In addition, since the middle page data corresponding to charge states S6, S7, S8, and S9 is consistent (corresponding to “0”), it does not need the recovery. In view of this, as long as the memory controller 110 utilizes specific programming schemes and processes to store data, it can perfectly perform data recovery by backing up only one of the middle page data and the lower page data, without needing to fully back up both of the middle page data and the lower page data. Therefore, the memory controller 110 of this invention can back up a lesser amount of data in a multi-pass programming scheme. Please note that although lower page data of memory cells is backed up in the above embodiments, in other embodiments of the present invention, middle page data of the memory cells may be chosen for backup (instead of backing up the lower page data), depending on the programming scheme. Additionally, in this embodiment, memory cells are programmed as MLC memory cells in the first programming pass and then programmed as QLC memory cells in the second programming pass, but this is not a limitation of the present invention. According to various embodiments, the data recovery method can also be applicable to programming processes of different types. For example, a programming process where memory cells are programmed as MLC memory cells in the first programming pass and then programmed as TLC memory cells in the second programming pass is also applicable to the data recovery method of the present invention. In summary, since the data recovery method of the present invention requires backing up a lesser amount of data, it effectively enhances writing efficiency (backing up more data might reduce writing efficiency) while ensuring data integrity and data storage reliability.

Embodiments in accordance with the present embodiments can be implemented as an apparatus, method, or computer program product. Accordingly, the present embodiments may take the form of an entirely hardware embodiment, an entirely software embodiment, or an embodiment combining software and hardware aspects that can all generally be referred to herein as a “module” or “system.” Furthermore, the present embodiments may take the form of a computer program product embodied in any tangible medium of expression having computer-usable program code embodied in the medium. In terms of hardware, the present invention can be accomplished by applying any of the following technologies or related combinations: an individual operation logic with logic gates capable of performing logic functions according to data signals, and an application specific integrated circuit (ASIC), a programmable gate array (PGA) or a field programmable gate array (FPGA) with a suitable combinational logic.

The flowchart and block diagrams in the flow diagrams illustrate the architecture, functionality, and operation of possible implementations of systems, methods, and computer program products according to various embodiments of the present embodiments. In this regard, each block in the flowchart or block diagrams may represent a module, segment, or portion of code, which comprises one or more executable instructions for implementing the specified logical function(s). It is also noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions. These computer program instructions can be stored in a computer-readable medium that directs a computer or other programmable data processing apparatus to function in a particular manner, such that the instructions stored in the computer-readable medium produce an article of manufacture including instruction means which implement the function/act specified in the flowchart and/or block diagram block or blocks.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A data writing method for use in a flash memory, comprising:
configuring one or more blocks of a plurality of blocks of the flash memory as one or more single-level cell (SLC) blocks;
based on one or more first host write commands, writing one or more first user data, as requested by the one or more first host write commands, to lower pages of the one or more SLC blocks;
in response to determining that a writable space in the flash memory is below a first predetermined value, configuring the one or more SLC blocks as one or more multi-level cell (MLC) blocks; and
based on one or more second host write commands, writing one or more second user data, as requested by the one or more second host write commands, to middle pages of the one or more MLC blocks without performing a garbage collection operation;
wherein the one or more first user data are retained in lower pages of the one or more MLC blocks.

2. The data writing method of claim 1, further comprising:
in response to determining that the writable space in the flash memory falls between the first predetermined value and a second predetermined value, configuring the one or more MLC blocks as one or more triple-level cell (TLC) blocks; and
based on one or more third host write commands, writing one or more third user data, as requested by the one or more third host write commands, to upper pages of the one or more TLC blocks without performing a garbage collection operation;
wherein the one or more first user data are retained in lower pages of the one or more TLC blocks and the one or more second user data are retained in middle pages of the one or more TLC blocks.

3. The data writing method of claim 2, further comprising:
in response to determining that the writable space in the flash memory falls between the second predetermined value and a third predetermined value, configuring the one or more TLC blocks as one or more quad-level cell (QLC) blocks; and
based on one or more fourth host write commands, writing one or more fourth user data, as requested by the one or more fourth host write commands, to top pages of the one or more QLC blocks without performing a garbage collection operation;
wherein the one or more first user data are retained in lower pages of the one or more QLC blocks, the one or more second user data are retained in middle pages of the one or more QLC blocks, and the one or more third user data are retained in upper pages of the one or more QLC blocks.

4. The data writing method of claim 1, further comprising:
in response to determining that the writable space in the flash memory falls between the first predetermined value and a second predetermined value, configuring the one or more MLC blocks as one or more QLC blocks; and
based on one or more third host write commands, writing one or more third user data, as requested by the one or more third host write commands, to upper pages and top pages of the one or more QLC block without performing a garbage collection operation;
wherein the one or more first user data are retained in lower pages of the one or more QLC blocks, and the one or more second user data are retained in middle pages of the one or more QLC blocks.

5. A data recovery method for use in a flash memory, comprising:
during a first programming pass, programming a memory cell of the flash memory to a specific charge state, thereby to store middle page data and lower page data into the memory cell;
reading the memory cell to back up one of the middle page data and the lower page data stored in the memory cell to another memory cell in the flash memory;
upon detecting an error during or after a second programming pass, based on a current voltage of the memory cell and the backed-up one of the middle page data and the lower page data from the another memory cell of the flash memory, recovering the middle page data and the lower page data of the memory cell; and
writing back the recovered middle page data and the recovered lower page data to the flash memory.

6. The data recovery method of claim 5, further comprising:
during the first programming pass, programming the memory cell to one of a first charge state, a second charge state, a third charge state, and a fourth charge state, thereby storing the middle page data and the lower page data in the memory cell; and
during the second programming pass, programming the memory cell from the second charge state to one of the second charge state, a fifth charge state, a sixth charge state, and a seventh charge state, or programming the memory cell from the third charge state to one of the third charge state, an eighth charge state, a ninth charge state, and a tenth charge state, thereby storing top page data and upper page data in the memory cell;
wherein a voltage corresponding to at least one of the sixth and seventh charge states is higher than a voltage corresponding to at least one of the third and eighth charge states.

7. The data recovery method of claim 6, wherein voltages corresponding to the sixth and seventh charge states are both higher than voltages corresponding to the third and eighth charge states.

8. The data recovery method of claim 5, wherein the first to tenth charge states are mapped to a plurality of different 4-bit data based on gray-code mapping principle.

9. A memory controller for use in a flash memory, comprising:
a storage unit configured to store program codes;
a processing unit configured to execute the program code to perform write operations on the flash memory, comprising:
configuring one or more blocks of a plurality of blocks of the flash memory as one or more single-level cell (SLC) blocks;
based on one or more first host write commands, writing one or more first user data, as requested by the one or more first host write commands, to lower pages of the one or more SLC blocks;
in response to determining that a writable space in the flash memory is below a first predetermined value, configuring the one or more SLC blocks as one or more multi-level cell (MLC) blocks; and
based on one or more second host write commands, writing one or more second user data, as requested by the one or more second host write commands, to middle pages of the one or more MLC blocks without performing a garbage collection operation;
wherein the one or more first user data are retained in lower pages of the one or more MLC blocks.

10. The memory controller of claim 9, wherein the processing unit is configured to perform operations of:
in response to determining that the writable space in the flash memory falls between the first predetermined value and a second predetermined value, configuring the one or more MLC blocks as one or more triple-level cell (TLC) blocks; and
based on one or more third host write commands, writing one or more third user data, as requested by the one or more third host write commands, to upper pages of the one or more TLC blocks without performing a garbage collection operation;
wherein the one or more first user data are retained in lower pages of the one or more TLC blocks and the one or more second user data are retained in middle pages of the one or more TLC blocks.

11. The memory controller of claim 10, wherein the processing unit is configured to perform operations of:
in response to determining that the writable space in the flash memory falls between the second predetermined value and a third predetermined value, configuring the one or more TLC blocks as one or more quad-level cell (QLC) blocks; and
based on one or more fourth host write commands, writing one or more fourth user data, as requested by the one or more fourth host write commands, to top pages of the one or more QLC blocks without performing a garbage collection operation;
wherein the one or more first user data are retained in lower pages of the one or more QLC blocks, the one or more second user data are retained in middle pages of the one or more QLC blocks, and the one or more third user data are retained in upper pages of the one or more QLC blocks.

12. The memory controller of claim 9, wherein the processing unit is configured to perform operations of:
in response to determining that the writable space in the flash memory falls between the first predetermined value and a second predetermined value, configuring the one or more MLC blocks as one or more QLC blocks; and
based on one or more third host write commands, writing one or more third user data, as requested by the one or more third host write commands, to upper pages and top pages of the one or more QLC block without performing a garbage collection operation;
wherein the one or more first user data are retained in lower pages of the one or more QLC blocks, and the one or more second user data are retained in middle pages of the one or more QLC blocks.

13. A memory controller for use in a flash memory, comprising:
a storage unit configured to store program codes;
a processing unit configured to execute the program code to perform write operations on the flash memory, comprising:
during a first programming pass, programming a memory cell of the flash memory to a specific charge state, thereby to store middle page data and lower page data into the memory cell;
reading the memory cell to back up one of the middle page data and the lower page data stored in the memory cell to another memory cell in the flash memory;
upon detecting an error during or after a second programming pass, based on a current voltage of the memory cell and the backed-up one of the middle page data and the lower page data from the another memory cell of the flash memory, recovering the middle page data and the lower page data of the memory cell; and
writing back the recovered middle page data and the recovered lower page data to the flash memory.

14. The memory controller of claim 13, wherein the processing unit is configured to perform operations of:
during the first programming pass, programming the memory cell to one of a first charge state, a second charge state, a third charge state, and a fourth charge state, thereby storing the middle page data and the lower page data in the memory cell; and
during the second programming pass, programming the memory cell from the second charge state to one of the second charge state, a fifth charge state, a sixth charge state, and a seventh charge state, or programming the memory cell from the third charge state to one of the third charge state, an eighth charge state, a ninth charge state, and a tenth charge state, thereby storing top page data and upper page data in the memory cell;
wherein a voltage corresponding to at least one of the sixth and seventh charge states is higher than a voltage corresponding to at least one of the third and eighth charge states.

15. The memory controller of claim 14, wherein voltages corresponding to the sixth and seventh charge states are both higher than voltages corresponding to the third and eighth charge states.

16. The memory controller of claim 13, wherein the first to tenth charge states are mapped to a plurality of different 4-bit data based on gray-code mapping principle.

17. A data storage device comprising a memory controller of claim 9 and a flash memory.

18. A data storage device comprising a memory controller of claim 13 and a flash memory.
